(19) United States
(12) Patent Application Publication
(10) Pub. No.: US 2025/0036118 A1
(43) Pub. Date: Jan. 30, 2025

(54) PREDICTIVE MAINTENANCE METHOD FOR INDUSTRIAL EQUIPMENT BASED ON MAINTENANCE PREDICTION MODEL EXPLAINABLE IN TIME-FREQUENCY DOMAIN AND APPARATUS FOR PERFORMING THE METHOD

(71) Applicant: HL MANDO CORPORATION, Pyeongtaek-si (KR)

(72) Inventors: Gyuwon KIM, Suwon-si (KR); Doheon LEE, Seoul (KR)

(73) Assignee: HL MANDO CORPORATION, Pyeongtaek-si (KR)

(21) Appl. No.: 18/385,095

(22) Filed: Oct. 30, 2023

(30) Foreign Application Priority Data
Jul. 13, 2023 (KR) 10-2023-0090894

(51) Int. Cl. G05B 23/02

(52) U.S. Cl. CPC G05B 23/0283; G05B 23/0254

(57) ABSTRACT

In a predictive maintenance method for industrial equipment based on a maintenance prediction model explainable in time-frequency domain according to one exemplary embodiment of the present disclosure and an apparatus for performing the method, it is possible to interpret the results of predictive maintenance by performing predictive maintenance (PdM) of the industrial equipment using a deep neural network-based maintenance prediction model explicable in the time-frequency domain.

### CROSS-REFERENCE TO RELATED APPLICATION

This application claims the benefit of priority to Korean Patent Application No. 10-2023-0090894, filed on Jul. 13, 2023 in the Korean Intellectual Property Office, the entire content of which is incorporated herein by reference.

### TECHNICAL FIELD

The present disclosure relates to a predictive maintenance method for industrial equipment based on a maintenance prediction model explainable in time-frequency domain and an apparatus for performing the method, and more specifically, to a method and apparatus for performing predictive maintenance (PdM) of industrial equipment.

### BACKGROUND

With the recent development of artificial intelligence technology, various industries are attempting deep neural network-based predictive maintenance (PdM). There are many machine learning (ML) and deep learning (DL)-based predictive maintenance methodologies, but most of them are black-box models in which the process of deriving the results of the algorithm is unknown. However, due to the black box nature of deep neural networks, it is difficult to apply them in the field. In addition, explainable artificial intelligence (XAI) algorithms have been proposed to solve this problem, but these are not end-to-end algorithms and have a problem in that additional overhead occurs.

The information disclosed in the Background section above is to aid in the understanding of the background of the present disclosure, and should not be taken as acknowledgement that this information forms any part of prior art.

### SUMMARY

According to various embodiments, the present disclosure is directed to a predictive maintenance method for industrial equipment based on a maintenance prediction model explainable in time-frequency domain and an apparatus for performing the method, which perform predictive maintenance (PdM) of industrial equipment using a deep neural network-based maintenance prediction model explainable in the time-frequency domain.

Other objects not specified in the present specification may be additionally considered within the scope that can be easily inferred from the following detailed description and effects thereof.

A predictive maintenance method for industrial equipment based on a maintenance prediction model that is explainable in a time-frequency domain, in accordance with one exemplary embodiment of the present disclosure, may include: obtaining target vibration signal data and target equipment data of a target industrial equipment; obtaining a target 2D short-time Fourier transform (STFT) image by preprocessing the target vibration signal data; and obtaining a remaining life of the target industrial equipment and derivation basis information on a basis for deriving the remaining life based on the target 2D STFT image and the target equipment data by using the maintenance prediction model that has been trained and built in advance.

The maintenance prediction model may include: a generative adversarial network (GAN) including a generator that generates the 2D STFT image based on a distribution and a discriminator that discriminates the 2D STFT image generated through the generator; and an encoder neural network that maps the 2D STFT image in a distribution.

The obtaining of the remaining life and the derivation basis information may include inputting the target 2D STFT image and the target equipment data to the maintenance prediction model, and obtaining the remaining life and the derivation basis information using a reconstructed 2D STFT image which is output data of the maintenance prediction model.

The obtaining of the remaining life and the derivation basis information may further include: inputting the target 2D STFT image and the target equipment data to the encoder neural network including a label embedding layer that transfers equipment data as a condition, and obtaining a target distribution corresponding to the target 2D STFT image, which is an output of the encoder neural network; inputting a discrete vector obtained based on the target distribution to the generator including a label embedding layer that converts the equipment data into a weight to be multiplied by a feature map channel to be transferred, and obtaining the reconstructed 2D STFT image which is an output of the generator; and obtaining the remaining life and the derivation basis information based on the target 2D STFT image and the reconstructed 2D STFT image.

The obtaining of the remaining life and the derivation basis information may further include obtaining the remaining life based on an anomaly score obtained based on the target 2D STFT image and the reconstructed 2D STFT image.

The obtaining of the remaining life and the derivation basis information may further include obtaining the anomaly score based on a mean squared error (MSE) representing a difference between the target 2D STFT image and the reconstructed 2D STFT image, a score of the discriminator, and an MSE representing a distance on the target distribution obtained through the encoder neural network.

The remaining life may be inversely proportional to the anomaly score.

The obtaining of the remaining life and the derivation basis information may further include obtaining the derivation basis information based on the MSE representing the difference between the target 2D STFT image and the reconstructed 2D STFT image.

The obtaining of the remaining life and the derivation basis information may further include obtaining the derivation basis information by visualizing the MSE representing the difference between the target 2D STFT image and the reconstructed 2D STFT image as a residual plot.

The target vibration signal data may include data representing a vibration signal for a predetermined direction of the target industrial equipment, and the target equipment data may include data representing a discrete value for a process average drill press force of the target industrial equipment and a discrete value for the number of drilling processes of the target industrial equipment.

A predictive maintenance apparatus for industrial equipment based on a maintenance prediction model that is explainable in a time-frequency domain, in accordance with one exemplary embodiment of the present disclosure, may include: a non-transitory memory storing one or more programs for performing predictive maintenance of the industrial equipment using the maintenance prediction model; and one or more processors for performing an operation for predictive maintenance of the industrial equipment using the maintenance prediction model in accordance with the one or more programs stored in the memory, wherein the one or more processors are configured to: obtain target vibration signal data and target equipment data of a target industrial equipment, obtain a target 2D short-time Fourier transform (STFT) image by preprocessing the target vibration signal data; and obtain a remaining life of the target industrial equipment and derivation basis information on a basis for deriving the remaining life based on the target 2D STFT image and the target equipment data by using the maintenance prediction model that has been trained and built in advance.

The maintenance prediction model may include: a generative adversarial network (GAN) including a generator that generates the 2D STFT image based on a distribution and a discriminator that discriminates the 2D STFT image generated through the generator; and an encoder neural network that maps the 2D STFT image in a distribution.

The one or more processors may input the target 2D STFT image and the target equipment data to the maintenance prediction model, and obtain the remaining life and the derivation basis information using a reconstructed 2D STFT image which is output data of the maintenance prediction model.

The one or more processors may input the target 2D STFT image and the target equipment data to the encoder neural network including a label embedding layer that transfers equipment data as a condition to obtain a target distribution corresponding to the target 2D STFT image, which is an output of the encoder neural network, input a discrete vector obtained based on the target distribution to the generator including a label embedding layer that converts the equipment data into a weight to be multiplied by a feature map channel to be transferred to obtain the reconstructed 2D STFT image which is an output of the generator, and obtain the remaining life and the derivation basis information based on the target 2D STFT image and the reconstructed 2D STFT image.

The one or more processors may obtain the remaining life based on an anomaly score obtained based on the target 2D STFT image and the reconstructed 2D STFT image.

The one or more processors may obtain the anomaly score based on a mean squared error (MSE) representing a difference between the target 2D STFT image and the reconstructed 2D STFT image, a score of the discriminator, and an MSE representing a distance on the target distribution obtained through the encoder neural network.

The remaining life may be inversely proportional to the anomaly score.

The one or more processors may obtain the derivation basis information based on the MSE representing the difference between the target 2D STFT image and the reconstructed 2D STFT image.

The one or more processors may obtain the derivation basis information by visualizing the MSE representing the difference between the target 2D STFT image and the reconstructed 2D STFT image as a residual plot.

The target vibration signal data may include data representing a vibration signal for a predetermined direction of the target industrial equipment, and the target equipment data may include data representing a discrete value for a process average drill press force of the target industrial equipment and a discrete value for the number of drilling processes of the target industrial equipment.

According to the predictive maintenance method for industrial equipment based on a maintenance prediction model explainable in time-frequency domain according to one exemplary embodiment of the present disclosure and the apparatus for performing the method, it is possible to interpret the results of predictive maintenance by performing predictive maintenance (PdM) of the industrial equipment using a deep neural network-based maintenance prediction model explicable in the time-frequency domain.

The effects of the present disclosure are not limited to the effects mentioned above, and other effects not mentioned will be clearly understood by those skilled in the art from the description below.

### BRIEF DESCRIPTION OF THE DRAWINGS

FIG. 1 is a block diagram for explaining a predictive maintenance apparatus for industrial equipment based on a maintenance prediction model explainable in a time-frequency domain according to one exemplary embodiment of the present disclosure.

FIG. 2 is a flowchart for explaining a predictive maintenance method for industrial equipment based on a maintenance predictive model explainable in a time-frequency domain according to one exemplary embodiment of the present disclosure.

FIG. 3 is a diagram for explaining a structure of the maintenance prediction model according to one exemplary embodiment of the present disclosure.

FIG. 4 is a diagram for explaining an example of a process of industrial equipment according to one exemplary embodiment of the present disclosure.

FIG. 5 is a diagram for explaining an example of a 2D STFT image according to one exemplary embodiment of the present disclosure.

FIG. 6 is a diagram for explaining a structure of a generative adversarial network shown in FIG. 3.

FIG. 7 is a diagram for explaining a soft-vicinal loss function used for training a discriminator shown in FIG. 6.

FIG. 8 is a diagram for explaining a structure of an encoder neural network shown in FIG. 3.

FIG. 9 is a diagram for explaining an anomaly detection process based on an anomaly score according to one exemplary embodiment of the present disclosure.

FIG. 10 is a diagram for explaining an example of predictive maintenance of industrial equipment according to one exemplary embodiment of the present disclosure.

### DETAILED DESCRIPTION

Hereinafter, embodiments of the present disclosure will be described in detail with reference to the accompanying drawings. Advantages and features of the present disclosure, and methods of achieving them, will become clear with reference to the embodiments that are described in detail below in conjunction with the accompanying drawings. However, the present disclosure is not limited to the embodiments described below, but may be implemented in various different forms, and the present embodiments are merely provided to make the description of the present disclosure complete, and to fully inform those skilled in the art to which the present disclosure pertains of the scope of the present disclosure. The present disclosure is only defined by the scope of the claims. Like reference numbers designate like components throughout the present specification.

Unless otherwise defined, all terms (including technical and scientific terms) used in the present specification may be used in a meaning that is commonly understood by those skilled in the art to which the present disclosure pertains. In addition, terms defined in commonly used dictionaries are not interpreted ideally or excessively unless specifically defined explicitly.

Terms, such as first, second, etc., are used to distinguish one component from another, and the scope of the claims should not be limited by these terms. For example, a first component may be referred to as a second component, and similarly, the second component may also be referred to as the first component.

In the present specification, identification codes (e.g., a, b, c, etc.) for each step are used for convenience of explanation, and identification codes do not describe the order of each step, and unless a specific order is not clearly described in context, each step may occur in a different order from the specified order. That is, the steps may be performed in the same order as specified, may be performed substantially simultaneously, or may be performed in the reverse order.

In the present specification, expressions such as “have or may have” and “include or may include” indicate the presence of a corresponding feature (e.g., numerical value, function, operation, or component such as a part), and do not preclude the presence of additional features.

Hereinafter, a predictive maintenance method for industrial equipment based on a maintenance prediction model explainable in a time-frequency domain and an apparatus for performing the method, according to one exemplary embodiment of the present disclosure, will be described in detail with reference to the accompanying drawings.

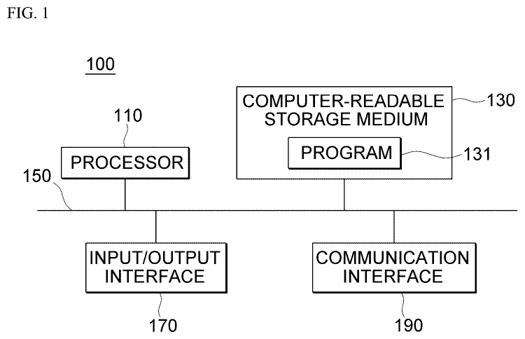

First, with reference to FIG. 1, a predictive maintenance apparatus for industrial equipment based on a maintenance prediction model explainable in a time-frequency domain according to one exemplary embodiment of the present disclosure will be described.

FIG. 1 is a block diagram for explaining the predictive maintenance apparatus for industrial equipment based on the maintenance prediction model explainable in the time-frequency domain according to one exemplary embodiment of the present disclosure.

Referring to FIG. 1, the predictive maintenance apparatus for industrial equipment (hereinafter referred to as ‘industrial equipment predictive maintenance apparatus’) 100 based on the maintenance prediction model explainable in the time-frequency domain according to one exemplary embodiment of the present disclosure can perform predictive maintenance (PdM) of industrial equipment using a deep neural network-based maintenance prediction model explainable in the time-frequency domain. Accordingly, the present disclosure can interpret the results of predictive maintenance.

That is, the present disclosure can perform predictive maintenance (PdM) of industrial equipment based on anomaly detection techniques through the maintenance prediction model including a generative adversarial network (GAN) and an encoder neural network by utilizing a short-time Fourier transform (STFT) image that visualizes vibration signal data of industrial equipment. In addition, the present disclosure can localize the residuals of the STFT image and interpret them in the time-frequency domain, and can overcome the shortcomings of the conventional black box model by localizing the residuals without applying additional explainable artificial intelligence (XAI) algorithms. Accordingly, the present disclosure can be easily applied to various industrial sites due to the interpretability of the results compared to the conventional black box model-based predictive maintenance method. In addition, the present disclosure can have advanced usability such as diagnosis of the cause of defects and detailed follow-up measures beyond simple judgment of defective/good products.

To this end, the industrial equipment predictive maintenance apparatus 100 may include one or more processors 110, a computer-readable storage medium 130, and a communication bus 150.

The processor 110 may control the operation of the industrial equipment predictive maintenance apparatus 100. For example, the processor 110 may be, e.g., a computer, a microprocessor, a CPU, an ASIC, a circuitry, logic circuits, etc. and may execute one or more programs 131 stored in the computer-readable storage medium 130. The one or more programs 131 may include one or more computer-executable instructions, and the computer-executable instructions may be configured to, when executed by the processor 110, cause the industrial equipment predictive maintenance apparatus 100 to perform operations for performing predictive maintenance (PdM) of industrial equipment using the maintenance prediction model.

The computer-readable storage medium 130 is configured to store computer-executable instructions or program codes, program data, and/or other suitable forms of information for performing predictive maintenance (PdM) of industrial equipment using the maintenance predictive model. The program 131 stored in the computer-readable storage medium 130 includes a set of instructions executable by the processor 110. In one embodiment, the computer-readable storage medium 130 includes a memory (a volatile memory such as random access memory, a non-volatile memory, or a suitable combination thereof), one or more magnetic disk storage devices, optical disk storage devices, flash memory devices, and other types of storage media that can be accessed by the industrial equipment predictive maintenance apparatus 100 and that can store desired information, or a suitable combination thereof.

The communication bus 150 interconnects the processor 110, the computer-readable storage medium 130, and various other components of the industrial equipment predictive maintenance apparatus 100.

The industrial equipment predictive maintenance apparatus 100 may further include one or more input/output interfaces 170 providing interfaces for one or more input/output devices, and one or more communication interfaces 190. The input/output interface 170 and the communication interface 190 are connected to the communication bus 150. An input/output device (not shown) may be connected to other components of the industrial equipment predictive maintenance apparatus 100 through the input/output interface 170.

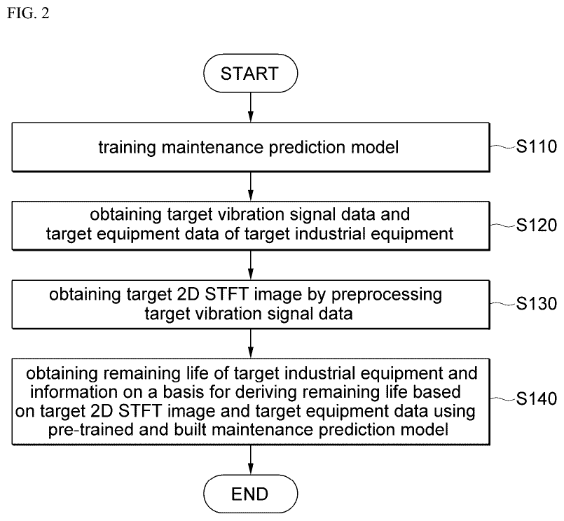

Next, a predictive maintenance method for industrial equipment based on a maintenance predictive model explainable in a time-frequency domain according to one exemplary embodiment of the present disclosure will be described with reference to FIGS. 2 to 10.

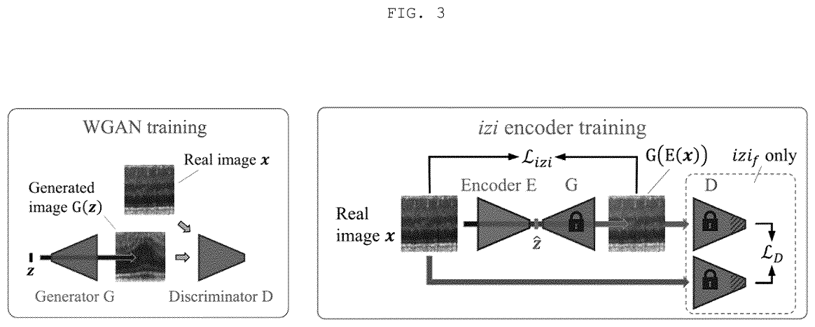

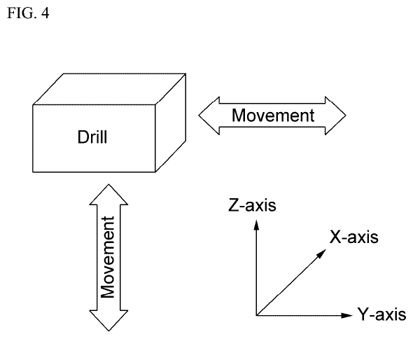

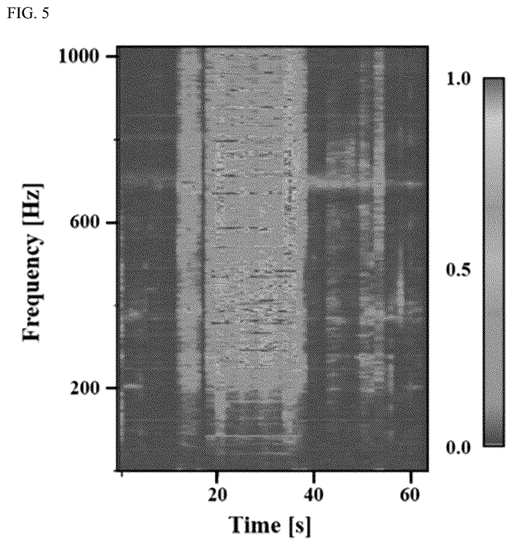

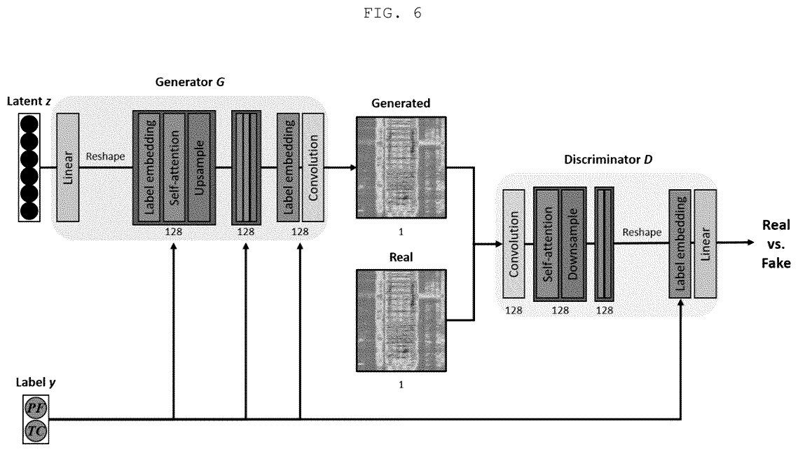

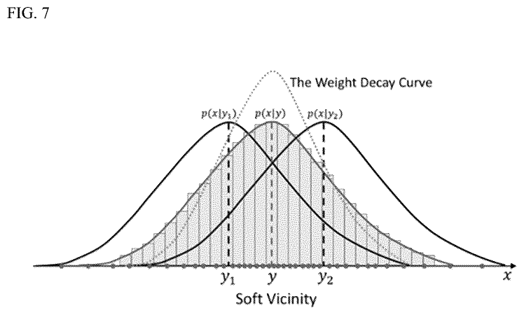

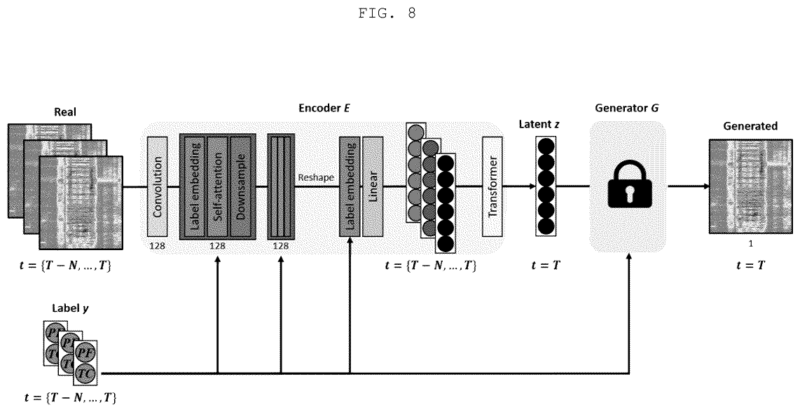

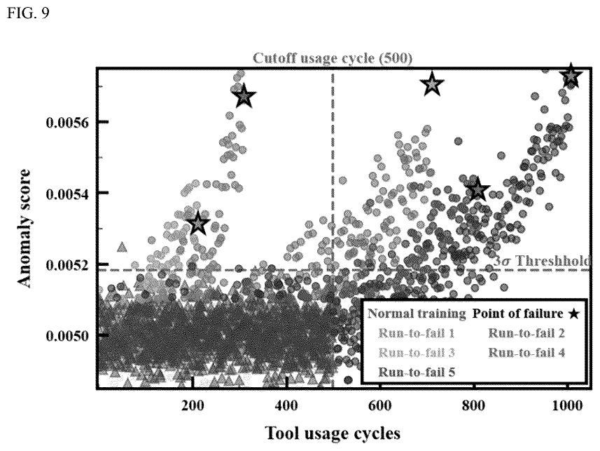

FIG. 2 is a flowchart for explaining the predictive maintenance method for industrial equipment based on the maintenance predictive model explainable in the time-frequency domain according to one exemplary embodiment of the present disclosure, FIG. 3 is a diagram for explaining a structure of the maintenance prediction model according to one exemplary embodiment of the present disclosure, FIG. 4 is a diagram for explaining an example of a process of industrial equipment according to one exemplary embodiment of the present disclosure, FIG. 5 is a diagram for explaining an example of a 2D STFT image according to one exemplary embodiment of the present disclosure, FIG. 6 is a diagram for explaining a structure of a generative adversarial network shown in FIG. 3, FIG. 7 is a diagram for explaining a soft-vicinal loss function used for training a discriminator shown in FIG. 6, FIG. 8 is a diagram for explaining a structure of an encoder neural network shown in FIG. 3, FIG. 9 is a diagram for explaining an anomaly detection process based on an anomaly score according to one exemplary embodiment of the present disclosure.

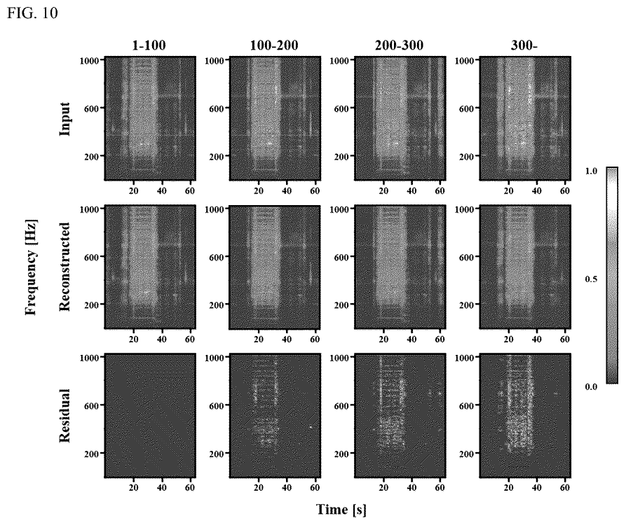

FIG. 10 is a diagram for explaining an example of predictive maintenance of industrial equipment according to one exemplary embodiment of the present disclosure.

Referring to FIG. 2, the processor 110 of the industrial equipment predictive maintenance apparatus 100 may train a maintenance prediction model (S110).

That is, the processor 110 may train and build the maintenance prediction model using training data including only normal data of industrial equipment.

In this case, shown in FIG. 3, the maintenance prediction model may include a generative adversarial network (GAN) including a generator that generates a 2D STFT image based on a distribution and a discriminator that discriminates the 2D STFT image generated through the generator, and an encoder neural network that maps the 2D STFT image in a distribution.

In addition, input data of the maintenance prediction model may include a 2D STFT image and equipment data. In this case, the 2D STFT image may be obtained by preprocessing vibration signal data obtained from industrial equipment through STFT. Unlike fast Fourier transform (FFT) in which time information disappears, STFT refers to a preprocessing technique capable of visualizing time-frequency information by performing FFT in a sliding-window manner. The vibration signal data may be data representing a vibration signal for a predetermined direction of industrial equipment. For example, when the industrial equipment is a “drill”, the processor 110 preprocesses the vibration signal data in the Y-axis direction of the “drill” shown in FIG. 4 through STFT to obtain a 3442 Hz 2D STFT image shown in FIG. 5. Further, the equipment data may represent data related to the process of industrial equipment. For example, when the industrial equipment is a “drill”, the equipment data may be a discrete value for a process average drill press force and a discrete value for the number of drilling processes (tool count).

Further, the training data is training data used for training the maintenance prediction model, and may include a 2D STFT image obtained from vibration signal data, which is normal data of industrial equipment, and equipment data, which are normal data of industrial equipment. For example, when the industrial equipment is a “drill”, the training data may include normal data measured when “tool count <500” for a drill that is broken at “tool count >800”.

More specifically, training of the maintenance prediction model may be performed sequentially by training of the generative adversarial network (GAN) and training of the encoder neural network. The training of the encoder neural network may use a generator of a trained generative adversarial network (GAN). In this case, the training of the encoder neural network may be performed after freezing parameters of the generator.

That is, the generative adversarial network (GAN) is a generator that generates a normal 2D STFT image based on a normal distribution, and a discriminator that compares a real 2D STFT image (real image) and a generated 2D STFT image (fake image) and discriminates the generated 2D STFT image (fake image). Referring to FIG. 6, the generative adversarial network (GAN) may operate in the same manner as a Wasserstein GAN (W-GAN). A basic input of the generative adversarial network (GAN) may be a discrete vector sampled from a normal distribution. The generator may reconstruct the input discrete vector to a normal 2D STFT image. The discriminator may compare a real 2D STFT image (real image) and a generated 2D STFT image (fake image) to discriminate the generated 2D STFT image (fake image). In this case, a label embedding layer may be added to each of the generator and the discriminator to convert equipment data (e.g., process average drill press force and the number of drilling processes), which is discrete value data, into a weight to be multiplied by a feature map channel, and may be transferred in a similar way to C-GAN (Conditional GAN).

The loss function LG of the generator is the same as the loss function of W-GAN, and is shown as in Equation 1 below.

$${L}_{G} = \frac{1}{N} \sum [ - D ( {x}_{Fake} ) ] \qquad ( Equation 1 )$$

The loss function L_{D} of the discriminator is shown as in Equation 2 below.

$${L}_{D} = \frac{1}{N} \sum [ D ( {x}_{Fake} ) - D ( {x}_{Real} ) ] + 10 \times \frac{1}{N} \sum [ {( {‖ {∇}_{{x}_{Fake}} D ( {x}_{Fake} ) ‖}_{2} - 1 )}^{2} ] + {L}_{SYDL} \qquad ( Equation 2 )$$

where the first and second terms are the same as the loss function of W-GAN. The third term represents a soft-vicinal loss function for efficiently conditioning discrete value data, as shown in FIG. 7 and Equation 3 below.

$$\begin{matrix}{\hat{ℒ}}^{SVDL} ( D ) = - \frac{{C}_{7}}{{N}^{r}} {\sum }_{j = 1}^{{N}^{r}} {\sum }_{i = 1}^{{N}^{r}} {𝔼}_{{ϵ}^{r} ∼ 𝒩 ( 0 , {σ}^{2} )} [ \frac{{w}^{r} ( {y}_{i}^{r} , {y}_{j}^{r} + {ϵ}^{r} )}{{\sum }_{i = 1}^{{N}^{r}} {w}^{r} ( {y}_{i}^{r} , {y}_{j}^{r} + {ϵ}^{r} )} log ( D ( {x}_{i}^{r} {y}_{j}^{r} + {ϵ}^{r} ) ) ] \\ - \frac{{C}_{8}}{{N}^{g}} {\sum }_{j = 1}^{{N}^{g}} {\sum }_{i = 1}^{{N}^{g}} {𝔼}_{{ϵ}^{g} ∼ 𝒩 ( 0 , {σ}^{2} )} \\ [ \frac{{w}^{g} ( {y}_{i}^{g} , {y}_{j}^{g} + {ϵ}^{g} )}{{\sum }_{i = 1}^{{N}^{g}} {w}^{g} ( {y}_{i}^{g} , {y}_{j}^{g} + {ϵ}^{g} )} log ( 1 - D ( {x}_{i}^{g} , {y}_{j}^{g} + {ϵ}^{g} ) ) ]\end{matrix} \qquad ( Equation 3 )$$

Further, the encoder neural network can map a normal 2D STFT image in a normal distribution. Referring to FIG. 8, the encoder neural network may receive a 2D STFT image as an input and map it in a normal distribution. In this case, the encoder neural network uses 2D STFT images for a current process and a past process together (dynamic encoding), which can be processed in a transformer layer in the encoder neural network. Like the generative adversarial network (GAN), the encoder neural network may use a label embedding layer to transfer equipment data (e.g., process average drill press force and the number of drilling processes), which is discrete value equipment data, as a condition by utilizing the label embedding layer.

The loss function L_{E} of the encoder neural network is as shown in Equation 4 below.

$${L}_{E} = \frac{1}{N} \sum \vert {x}_{Real} - {x}_{Fake} \vert - MSSSIM ( {x}_{Real} , {x}_{Fake} ) + 0.1 \times \frac{1}{N} \sum [ - D ( {x}_{Fake} ) ] \qquad ( Equation 4 )$$

where the first and second terms represent a supervised training loss function, and MSSSIM means a multi-stage structural similarity index. The third term represents an adversarial loss function using a discriminator that has been trained in advance.

Then, the processor 110 may obtain target vibration signal data and target equipment data of the target industrial equipment (S120).

In this case, the target industrial equipment represents industrial equipment for performing predictive maintenance (PdM). Further, the target vibration signal data represents vibration signal data obtained from the target industrial equipment, and the target equipment data represents equipment data obtained from the target industrial equipment.

For example, when the target industrial equipment is a “drill”, the target vibration signal data may be data representing a vibration signal for a predetermined direction of the “drill” that is the target industrial equipment. In addition, the target equipment data may be data indicating a discrete value of a process average drill press force of the target industrial equipment “drill” and a discrete value of the number of drilling processes of the target industrial equipment “drill”.

Thereafter, the processor 110 may obtain a target 2D STFT image by preprocessing the target vibration signal data (S130).

Next, the processor 110 may obtain a remaining life of the target industrial equipment and information on a basis for deriving the remaining life based on the target 2D STFT image and the target equipment data using the maintenance prediction model that has been trained and built in advance (S140).

That is, the processor 110 may input the target 2D STFT image and the target equipment data to the maintenance prediction model, and obtain the remaining life and the derivation basis information using the reconstructed 2D STFT image, which is output data of the maintenance prediction model.

More specifically, the processor 110 may input the target 2D STFT image and the target equipment data to the encoder neural network including the label embedding layer that transfers equipment data as a condition, and obtain a target distribution corresponding to the target 2D STFT image, which is an output of the encoder neural network.

Then, the processor 110 may input a discrete vector obtained based on the target distribution to the generator including the label embedding layer that converts the equipment data into a weight to be multiplied by the feature map channel to be transferred, and obtain the reconstructed 2D STFT image which is an output of the generator.

Further, the processor 110 may obtain the remaining life and the derivation basis information based on the target 2D STFT image and the reconstructed 2D STFT image.

That is, the processor 110 may obtain the remaining life based on an anomaly score obtained based on the target 2D STFT image and the reconstructed 2D STFT image. Specifically, the processor 110 may obtain an anomaly score based on a mean squared error (MSE) representing a difference between the target 2D STFT image and the reconstructed 2D STFT image, a score of the discriminator, and an MSE representing the distance on the target distribution obtained through the encoder neural network. In this case, the remaining life may be inversely proportional to the anomaly score. For example, referring to FIG. 9, the processor 110 may perform 30-based anomaly detection using the sum of the difference (MSE) between the target 2D STFT image and the reconstructed 2D STFT image, the score of the discriminator, and the distance (MSE) on the target distribution obtained through the encoder neural network as the anomaly score. The processor 110 may determine that the remaining life is shorter as the anomaly score increases.

In addition, the processor 110 may obtain the derivation basis information based on the MSE representing the difference between the target 2D STFT image and the reconstructed 2D STFT image. That is, the processor 110 may obtain the derivation basis information by visualizing the MSE representing the difference between the target 2D STFT image and the reconstructed 2D STFT image as a residual plot. Accordingly, the time-frequency domain of a damage inducing factor can be confirmed through the derivation basis information visualized as the residual plot.

For example, in FIG. 10, the first row represents the input 2D STFT image, the second row represents the reconstructed 2D STFT image, and the third row represents the residual plot indicating the difference between the input 2D STFT image and the reconstructed 2D STFT image. Each column in FIG. 10 indicates the number of times of use of a tool, which is industrial equipment, and the number of times of use of the tool increases as it goes to the right, leading to the progression of damage. In the first column (number of tool use 1-100), the input 2D STFT image belongs to the trained normal distribution, and the difference with the reconstructed 2D STFT image is small, which can be confirmed through the residual plot. In the case of the second column (number of tool use 100-200), it can be seen that tool breakage is gradually progressing and residuals occur in a low frequency range of 200 to 600 Hz. In the case of the third column (number of tool use 200-300), it can be seen that the residual gradually expands to a high-frequency region of 600 to 1000 Hz. In the residual plot in the fourth column (number of tool use 300-), the residuals covering the entire frequency range of 200 to 1000 Hz can be seen. Considering the physical factor in which the damage of the industrial equipment “drill” gradually causes high-frequency vibration, in the case of the fourth column (number of times of tool use 300-), there is a possibility of damage even if the replacement cycle has not been reached, so replacement may be recommended.

The operations according to the present embodiments may be implemented in the form of program instructions that can be executed through various computer means, and recorded in a computer-readable storage medium. The computer-readable storage medium refers to any medium that participates in providing instructions to a processor for execution. The computer-readable storage medium may include program instructions, data files, data structures, or combinations thereof. For example, there may be a magnetic medium, an optical recording medium, a memory, and the like. The computer program may be distributed over networked computer systems so that computer-readable codes are stored and executed in a distributed manner. Functional programs, codes, and code segments for implementing the present embodiments may be easily inferred by programmers in the art to which the present disclosure pertains.

The present embodiments are for explaining the technical idea of the present disclosure, and the scope of the technical idea of the present disclosure is not limited by these embodiments. The scope of protection of the present disclosure should be interpreted according to the claims below, and all technical ideas within the scope equivalent thereto should be construed as being included in the scope of the claims of the present disclosure.

What is claimed is:

1. A predictive maintenance method for industrial equipment based on a maintenance prediction model that is explainable in a time-frequency domain, the method comprising:
obtaining target vibration signal data and target equipment data of a target industrial equipment;
obtaining a target 2D short-time Fourier transform (STFT) image by preprocessing the target vibration signal data; and
obtaining a remaining life of the target industrial equipment and derivation basis information on a basis for deriving the remaining life based on the target 2D STFT image and the target equipment data by using the maintenance prediction model that has been trained and built in advance.

2. The predictive maintenance method of claim 1, wherein the maintenance prediction model includes:
a generative adversarial network (GAN) including a generator that generates the 2D STFT image based on a distribution and a discriminator that discriminates the 2D STFT image generated through the generator; and
an encoder neural network that maps the 2D STFT image in a distribution.

3. The predictive maintenance method of claim 2, wherein the obtaining of the remaining life and the derivation basis information includes:
inputting the target 2D STFT image and the target equipment data to the maintenance prediction model; and
obtaining the remaining life and the derivation basis information using a reconstructed 2D STFT image which is output data of the maintenance prediction model.

4. The predictive maintenance method of claim 3, wherein the obtaining of the remaining life and the derivation basis information further includes:
inputting the target 2D STFT image and the target equipment data to the encoder neural network including a label embedding layer that transfers equipment data as a condition, and obtaining a target distribution corresponding to the target 2D STFT image, which is an output of the encoder neural network;
inputting a discrete vector obtained based on the target distribution to the generator including a label embedding layer that converts the equipment data into a weight to be multiplied by a feature map channel to be transferred, and obtaining the reconstructed 2D STFT image which is an output of the generator; and
obtaining the remaining life and the derivation basis information based on the target 2D STFT image and the reconstructed 2D STFT image.

5. The predictive maintenance method of claim 4, wherein the obtaining of the remaining life and the derivation basis information further includes obtaining the remaining life based on an anomaly score obtained based on the target 2D STFT image and the reconstructed 2D STFT image.

6. The predictive maintenance method of claim 5, wherein the obtaining of the remaining life and the derivation basis information further includes obtaining the anomaly score based on a mean squared error (MSE) representing a difference between the target 2D STFT image and the reconstructed 2D STFT image, a score of the discriminator, and an MSE representing a distance on the target distribution obtained through the encoder neural network.

7. The predictive maintenance method of claim 6, wherein the remaining life is inversely proportional to the anomaly score.

8. The predictive maintenance method of claim 4, wherein the obtaining of the remaining life and the derivation basis information further includes obtaining the derivation basis information based on an MSE representing a difference between the target 2D STFT image and the reconstructed 2D STFT image.

9. The predictive maintenance method of claim 8, wherein the obtaining of the remaining life and the derivation basis information further includes obtaining the derivation basis information by visualizing the MSE representing the difference between the target 2D STFT image and the reconstructed 2D STFT image as a residual plot.

10. The predictive maintenance method of claim 1, wherein the target vibration signal data includes data representing a vibration signal for a predetermined direction of the target industrial equipment, and the target equipment data includes data representing a discrete value for a process average drill press force of the target industrial equipment and a discrete value for the number of drilling processes of the target industrial equipment.

11. A predictive maintenance apparatus for industrial equipment based on a maintenance prediction model that is explainable in a time-frequency domain, the apparatus comprising:
a non-transitory memory storing one or more programs for performing predictive maintenance of the industrial equipment using the maintenance prediction model; and
one or more processors for performing an operation for predictive maintenance of the industrial equipment using the maintenance prediction model in accordance with the one or more programs stored in the memory,
wherein the one or more processors are configured to:
obtain target vibration signal data and target equipment data of a target industrial equipment,
obtain a target 2D short-time Fourier transform (STFT) image by preprocessing the target vibration signal data; and
obtain a remaining life of the target industrial equipment and derivation basis information on a basis for deriving the remaining life based on the target 2D STFT image and the target equipment data by using the maintenance prediction model that has been trained and built in advance.

12. The predictive maintenance apparatus of claim 11, wherein the maintenance prediction model includes:
a generative adversarial network (GAN) including a generator that generates the 2D STFT image based on a distribution and a discriminator that discriminates the 2D STFT image generated through the generator; and
an encoder neural network that maps the 2D STFT image in a distribution.

13. The predictive maintenance apparatus of claim 12, wherein the one or more processors input the target 2D STFT image and the target equipment data to the maintenance prediction model, and obtain the remaining life and the derivation basis information using a reconstructed 2D STFT image which is output data of the maintenance prediction model.

14. The predictive maintenance apparatus of claim 13, wherein the one or more processors input the target 2D STFT image and the target equipment data to the encoder neural network including a label embedding layer that transfers equipment data as a condition to obtain a target distribution corresponding to the target 2D STFT image, which is an output of the encoder neural network, input a discrete vector obtained based on the target distribution to the generator including a label embedding layer that converts the equipment data into a weight to be multiplied by a feature map channel to be transferred to obtain the reconstructed 2D STFT image which is an output of the generator, and obtain the remaining life and the derivation basis information based on the target 2D STFT image and the reconstructed 2D STFT image.

15. The predictive maintenance apparatus of claim 14, wherein the one or more processors obtain the remaining life based on an anomaly score obtained based on the target 2D STFT image and the reconstructed 2D STFT image.

16. The predictive maintenance apparatus of claim 15, wherein the one or more processors obtain the anomaly score based on a mean squared error (MSE) representing a difference between the target 2D STFT image and the reconstructed 2D STFT image, a score of the discriminator, and an MSE representing a distance on the target distribution obtained through the encoder neural network.

17. The predictive maintenance apparatus of claim 16, wherein the remaining life is inversely proportional to the anomaly score.

18. The predictive maintenance apparatus of claim 14, wherein the one or more processors obtain the derivation basis information based on an MSE representing a difference between the target 2D STFT image and the reconstructed 2D STFT image.

19. The predictive maintenance apparatus of claim 18, wherein the one or more processors obtain the derivation basis information by visualizing the MSE representing the difference between the target 2D STFT image and the reconstructed 2D STFT image as a residual plot.

20. The predictive maintenance apparatus of claim 11, wherein the target vibration signal data includes data representing a vibration signal for a predetermined direction of the target industrial equipment, and the target equipment data includes data representing a discrete value for a process average drill press force of the target industrial equipment and a discrete value for the number of drilling processes of the target industrial equipment.
